(19) United States
(12) Patent Application Publication
(10) Pub. No.: US 2007/0229441 A1
(43) Pub. Date: Oct. 4, 2007

(54) Display device

(75) Inventors: Po-Yuan Liu, Hsinchu City (TW); Ming-Sheng Lai, Taipei City (TW); Kuo-Hsing Cheng, Taipei City (TW); Wan-Jung Chen, Pingtung City (TW)

Correspondence Address: RABIN & Berdo, PC, 1101 14TH STREET, NW, SUITE 500, WASHINGTON, DC, 20005, US

(73) Assignee: AU OPTRONICS CORP., Hsinchu (TW)

(21) Appl. No.: 11/519,953

(22) Filed: Sep. 13, 2006

(30) Foreign Application Priority Data
Mar. 30, 2006 (TW) 95111319

(51) Int. Cl. G09G 3/36

(52) U.S. Cl. 345/100

(57) ABSTRACT

A display device is disclosed, which has a printed circuit board, a display panel, data driver chips and a scan driver circuit. The display panel has a substrate, scan lines and data lines. The scan lines are disposed on the substrate, and the data lines perpendicular to the scan lines are disposed on the substrate. The data driver chips, which are cascaded and mounted on the substrate, are electrically connected to the data lines and the printed circuit board. The scan driver circuit is formed on the substrate and electrically connected to the scan lines and the printed circuit board.

### RELATED APPLICATIONS

The present application is based on, and claims priority from, Taiwan Patent Application Serial Number 95111319, filed Mar. 30, 2006, the disclosure of which is hereby incorporated by reference herein in its entirety.

### BACKGROUND

1. Field of Invention

The present invention relates to a flat panel display. More particularly, the present invention relates to a display device.

2. Description of Related Art

Conventional display panels have two types of tape carrier packages (TCPs). Each type of TCPs solely packages data driver chips or scan driver chips, which are respectively connected to the data lines or the scan lines for driving the pixels of the display panel. Display panel demand and cost concern have created a tendency to omit the additional tape carrier packages, for example, by directly bonding driver chips on the glass substrate (i.e. Chip On Glass; COG).

FIG. 1A shows a conventional display module implementing the COG technique. The COG technique omits the additional tape carrier packages disposed on the scan driver side 104 of the display panel 108, and instead cascades scan driver chips 114 to receive signals from a printed circuit board 106 on the data driver side 102 of the display panel 108, then the cascaded scan driver chips transmit signals to the scan lines.

FIG. 1B shows the FIG. 1A display module circuit diagram, illustrating the circuits and signal transitions among the scan driver chips 114 and the printed circuit board 106. Typically, the scan driver chip 114 includes a shift register (not shown) and a level shifter (not shown), and the printed circuit board 106 includes a connector 122, an ASIC (Application Specific Integrated Circuit) 124, a DC/DC converter 126 and a gamma corrector 128.

The connector 122 of the printed circuit board 106 connects a system interface 132. The ASIC 124 includes a receiver 142, a timing controller 144 and a transmitter 146 to provide data and control signals, such as RGB, XDIO, XSTB, POL and YDIO, YCLK, YOE, to the data driver chips 112 and the scan driver chips 114, respectively. The DC/DC converter 126 provides power signals to the gamma corrector 128, the data driver chips 112 and the scan driver chips 114.

The digital level control signals, such as YDIO and YCLK, are initially inputted into the shift register of the scan driver chip 114, and then the sequential digital signals are processed by the scan driver chip 114 and amplified by the level shifter to analog signals, which are outputted as the gate pulses for scanning the display panel 108.

### SUMMARY

The present invention provides a display device, which comprises a printed circuit board, a display panel, a plurality of data driver chips and a scan driver circuit. The display panel comprises a substrate, a plurality of scan lines and a plurality of data lines. The scan lines are disposed on the substrate, and the data lines perpendicular to the scan lines are disposed on the substrate. The data driver chips, which are cascaded and mounted on the substrate, are electrically connected to the data lines and the printed circuit board. The scan driver circuit is formed on the substrate and electrically connected to the scan lines and the printed circuit board.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A shows a conventional display device implementing the COG technique;

FIG. 1B shows the circuit diagram of the display device in FIG. 1A;

FIG. 2A is one preferred embodiment of the present invention;

FIG. 2B shows the circuit diagram of the display device in FIG. 2A;

FIG. 3A is a top view of a top-gate thin-film transistor according to one preferred embodiment;

FIG. 3B is a lateral view of the top-gate thin-film transistor in FIG. 3A;

FIG. 4A is a top view of a bottom-gate thin-film transistor according to another preferred embodiment; and

FIG. 4B is a lateral view of the bottom-gate thin-film transistor in FIG. 4A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The embodiments of the present invention cascade the data driver chips on the data driver side, and directly forms the scan driver circuit on the substrate on the scan driver side instead of bonding the scan driver chips on the substrate. Therefore, on the data driver side, the circuit design of the printed circuit board is simplified and the printed circuit board size is reduced, the number and the size of the required flexible printed circuit boards are also reduced, thus decreasing the cost; on the scan driver side, the cost of the scan driver chips is saved, and the reliability of the display panel is improved because of a reduced number of connecting terminals.

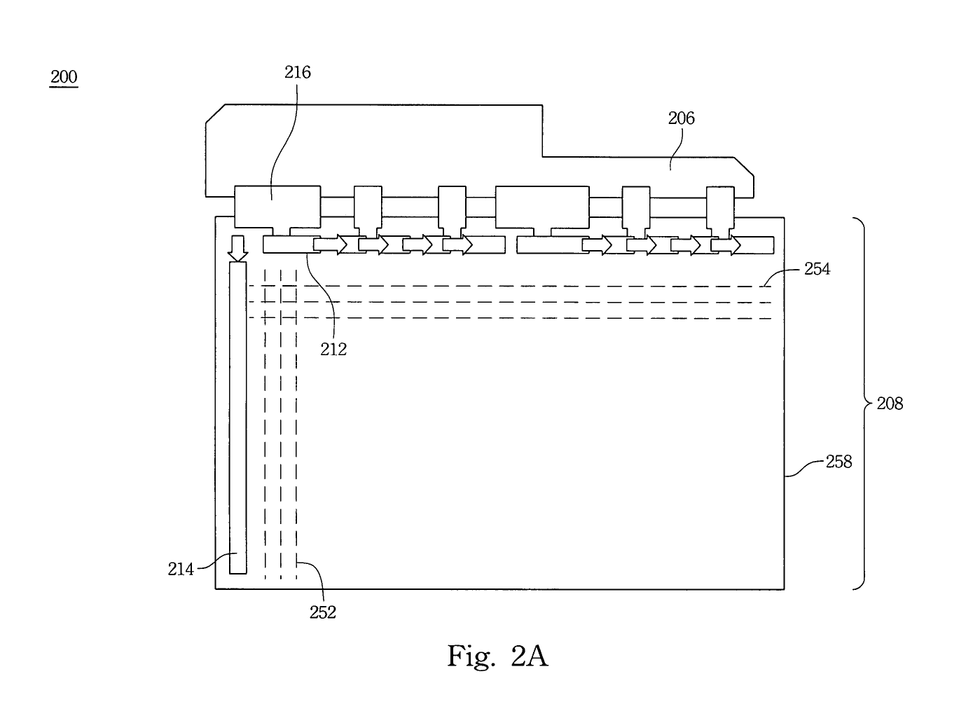

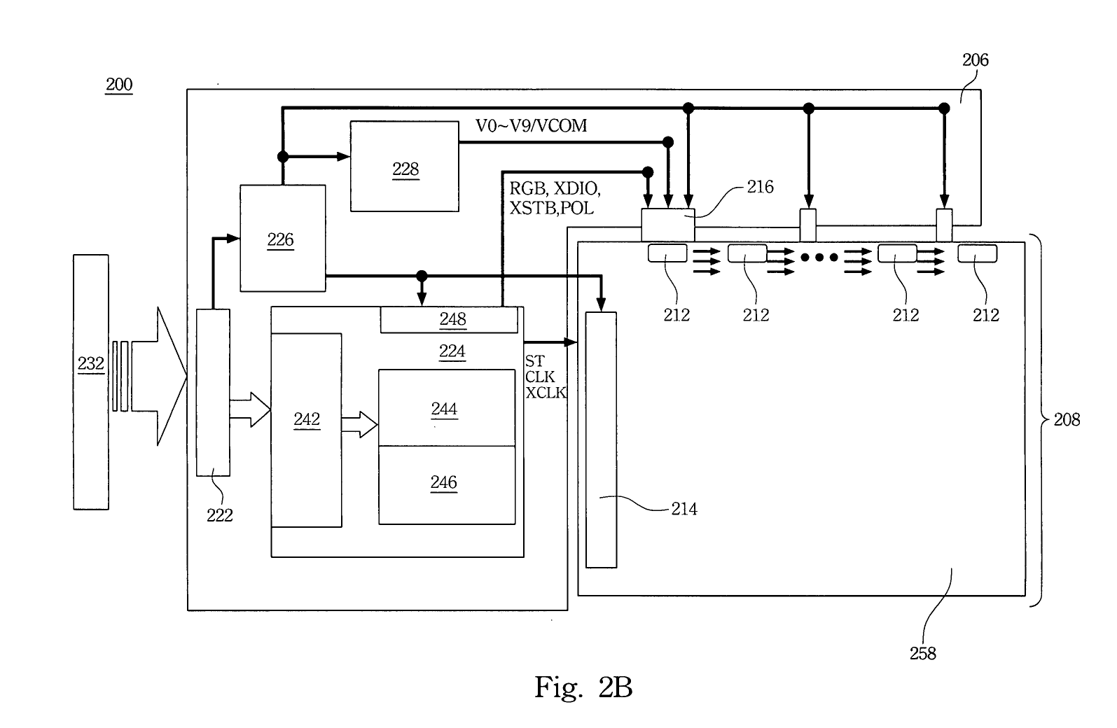

FIG. 2A is a schematic view of one preferred embodiment of the present invention. A display device 200 has a printed circuit board 206, a display panel 208, driver chips 212 and a scan driver circuit 214. The display panel 208 has a substrate 258, scan lines 254 and data lines 252. The scan lines 254 are disposed on the substrate 258, and the data lines 252 perpendicular to the scan lines 254 are disposed on the substrate 258. The data driver chips 212, which are cascaded and mounted on the substrate 258, are electrically connected to the data lines 252 and the printed circuit board 206. The scan driver circuit 214 is formed on the substrate 258 and electrically connected to the scan lines 254 and the printed circuit board 206.

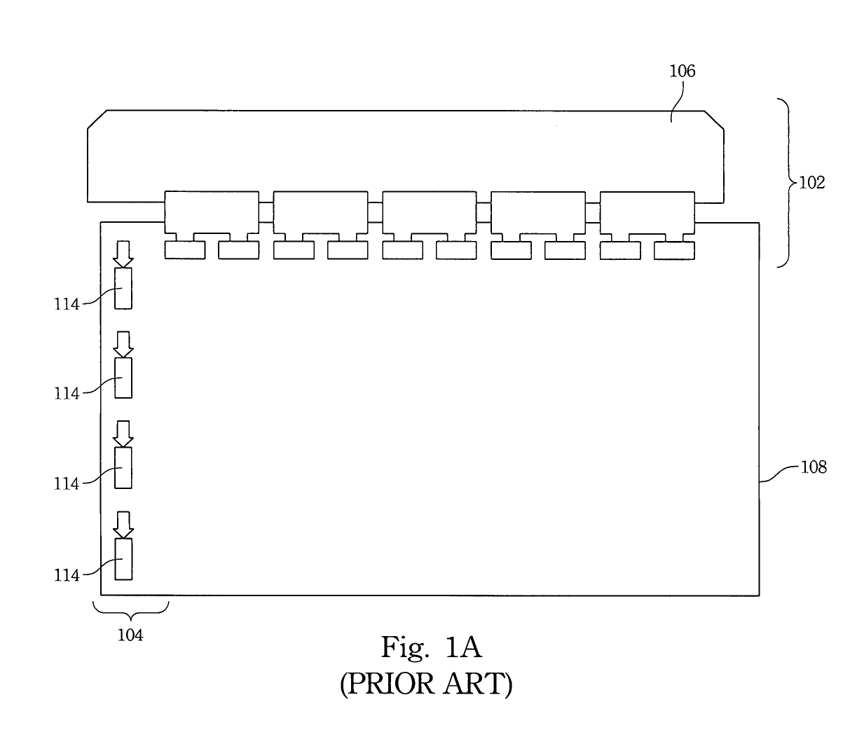

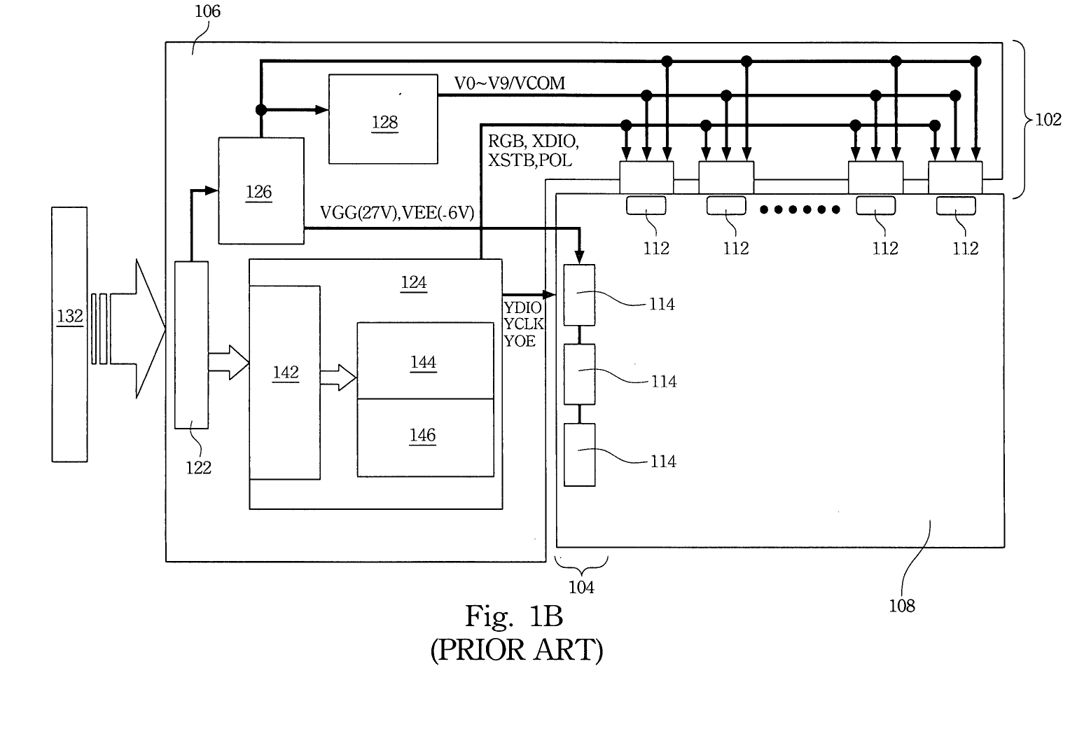

FIG. 2B is a circuit diagram of the display device in FIG. 2A, illustrating the circuits and signal transitions among the scan driver circuit 214 and the printed circuit board 206. The data driver chips 212 and the scan driver circuit 214 are on two adjacent sides of the substrate 258, respectively. The scan driver circuit 214 includes at least one shift register (not shown) electrically connected to the scan lines 254. The shift register can have several switching elements electrically connected to one another, and the switching element can be a top-gate thin-film transistor or a bottom-gate thin-film transistor. In other words, the shift register in the preferred embodiment is a circuit directly formed on the substrate 258, different from the architecture contained within the scan driver chip 114 as illustrated in FIG. 1B.

In the preferred embodiment, the printed circuit board 206 includes a connector 222, an ASIC (Application Specific Integrated Circuit) 224, a DC/DC converter 226 and a gamma corrector 228. The connector 222 of the printed circuit board 206 connects a system interface 232. The ASIC 224 includes a receiver 242, a timing controller 244, a transmitter 246 and a level shifter 248 to provide data and control signals, such as RGB, XDIO, XSTB, POL and ST, CLK, XCLK, to the data driver chips 212 and the scan driver circuit 214, respectively. The DC/DC converter 226 provides power signals to the gamma corrector 228, the level shifter 248 in the ASIC 224, the data driver chips 212 and the scan driver circuit 214.

The level shifter 248 can be integrated in the ASIC 224 as mentioned above, or can be an independent chip.

By this architecture, the analog level pulsed signals, such as ST (start pulse), CLK, XCLK (inverted CLK), can be directly transmitted from the level shifter 248 on the printed circuit board 206 to the shift register on the display panel 208, then to output the required gate pulses for scanning the display panel 208. Generally, the high level of the gate pulse is about +27V and the low level of the gate pulse is about −6V.

Moreover, the display device 200 can have at least a flexible printed circuit board 216 disposed between the printed circuit board 206 and the data driver chips 212, to transmit signals therebetween. The flexible printed circuit boards 216 can be regularly configured to correspond to the data driver chips 212. Alternatively, when the signal transmission quality is good, the flexible printed circuit board 216 can be configured on only one end of the printed circuit board 206, and the signals are thus transmitted by being cascaded through the data driver chips 212.

Besides, the display device 200 can transmit signals from the printed circuit board 206 to the scan driver circuit 214 through another flexible printed circuit 216. Alternatively, the printed circuit board 206 can transmit signals to the scan driver circuit 214 through the cascaded data driver chip 212. The foregoing embodiments exemplarily illustrate the subject matter of the present invention rather than limit the invention, and other implementations, which conform to the spirit of the invention, should be included in the scope of the present invention.

The display panel 208 further has an upper substrate and a liquid crystal layer (not shown) in addition to the substrate 258, the scan lines 254 and the data lines 252. The upper substrate is disposed parallel to the substrate 258, and the liquid crystal layer is disposed between the upper substrate and the substrate 258. The upper substrate includes at least a color filter layer. The scan lines 254 and the data lines 252 can define an array of pixels. The display panel 208 further has switching elements (not shown) correspondingly configured within the pixels and electrically connected to the scan lines 254 and the data lines 252. The scan driver circuit 214 simultaneously includes switching elements with different types.

The switching element, according to the preferred embodiment, can be a LTPS (Low Temperature Poly Silicon) thin-film transistor, a μc-Si (Micro Crystalline Silicon) thin-film transistor or an a-Si (Amorphous Silicon) thin-film transistor, and the structure of the switching element can be a top-gate structure or a bottom-gate structure. In addition, the μc-Si thin-film transistor is simultaneously suitable for the top-gate thin-film transistor and the bottom-gate thin-film transistor.

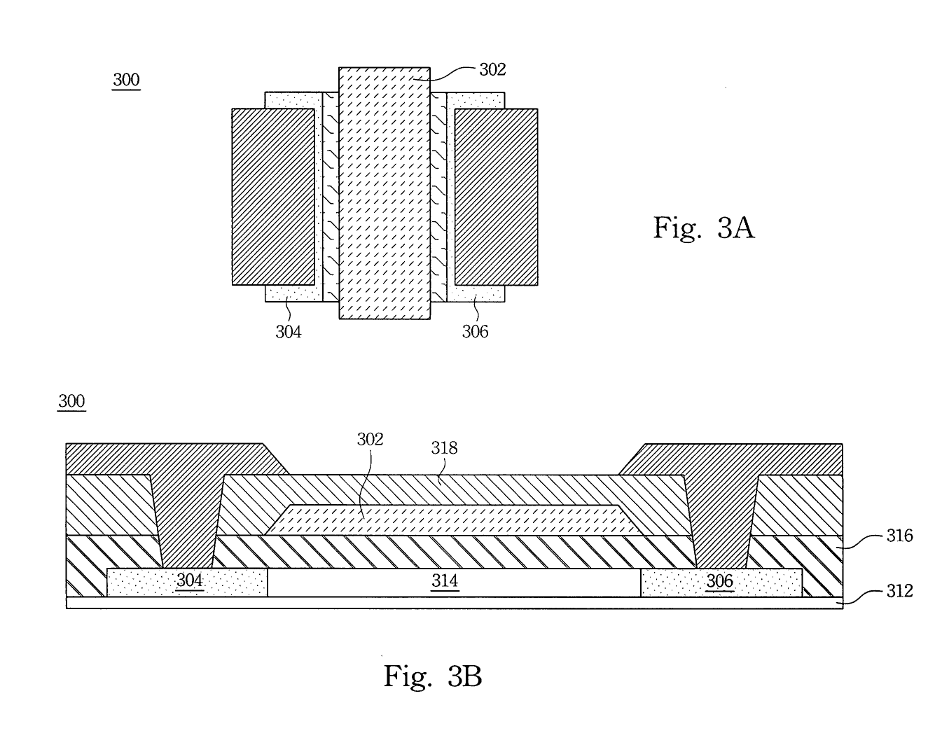

FIG. 3A is a top view of a top-gate thin-film transistor according to one preferred embodiment, and FIG. 3B is a lateral view of the top-gate thin-film transistor. For example, the top-gate thin-film transistor 300 is a LTPS thin-film transistor, of which the gate region 302 (the first metal layer) is over the drain region 304 and the source region 306.

More particularly, the drain region 304 and the source region 306 of N+ or P+ polysilicon are formed on a buffer oxide layer 312. The drain region 304 is separated from the source region 306 with a polysilicon layer 314 of which two ends are lightly doped drains (LDD) (not shown). A gate oxide layer 316 is disposed over the polysilicon layer 314, the drain region 304 and the source region 306. The gate region 302 of the first metal layer is formed on the gate oxide layer 316, and also disposed over the polysilicon layer 314. The gate oxide layer 316 and the gate region 302 are covered with a passivation layer, for example, a nitride (p-SiNx) layer 318.

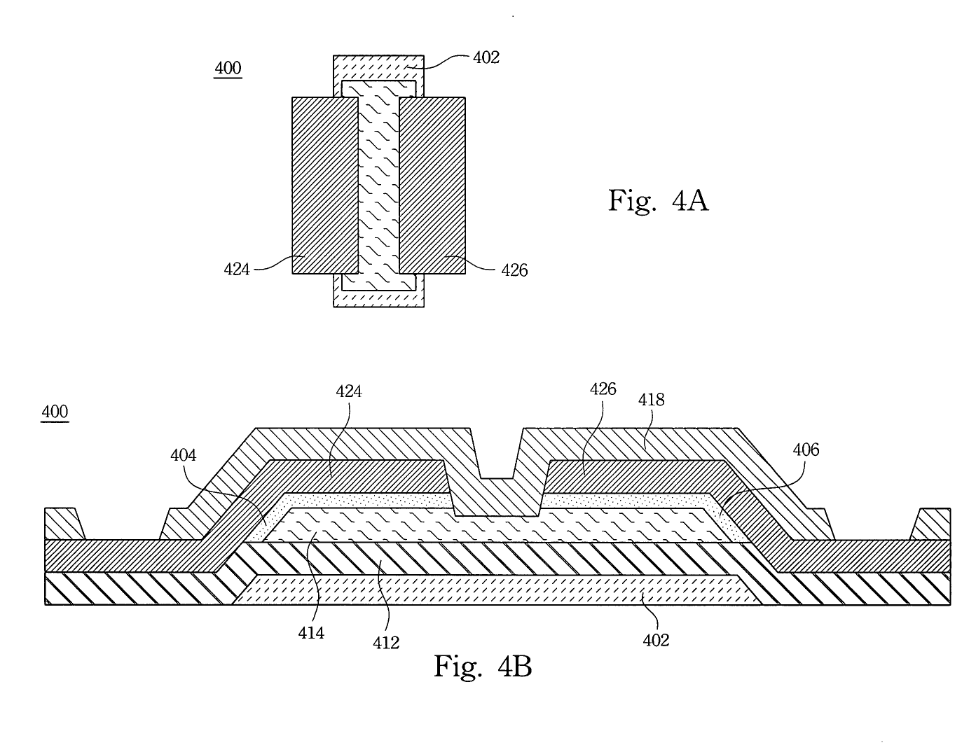

FIG. 4A is a top view of a bottom-gate thin-film transistor according to another preferred embodiment, and FIG. 4B is a lateral view of the bottom-gate thin-film transistor. For example, the top-gate thin-film transistor 400 is an a-Si thin-film transistor, of which the gate region 402 (the first metal layer) is lower than the drain region 404 and the source region 406.

More particularly, the drain region 404 and the source region 406 of N+ or P+ amorphous silicon are formed on an amorphous silicon layer 414. A gate nitride layer 412 is disposed between the amorphous silicon layer 414 and the gate region 402. A drain electrode 424 is disposed on the drain region 404, and a source electrode 426 is disposed on the drain region 406. The drain electrode 424 and the source electrode 426 are capped with a passivation layer, for example, a nitride (p-SiNx) layer 418.

The top-gate thin-film transistor and the bottom-gate thin-film transistor provided by FIG. 3B and FIG. 4B can be integrated with the scan driver circuit of the preferred embodiment of the present invention. More precisely, because of the top-gate thin-film transistor 300 or the bottom-gate thin-film transistor 400 which can be formed on the substrate 258, the scan driver circuit 214 can be directly integrated and formed on the substrate 258.

Furthermore, according to the embodiment of the present invention, the display panel can be a liquid crystal display panel or an organic light emitting diode display panel. That is, persons skilled in the art can modify or improve the display module of the present invention for the organic light emitting diode display panel or the like.

In conclusion, the preferred embodiments can save the cost of components by the scan driver circuit formed on the substrate instead of the conventional scan driver chips disposed on the scan driver side. Moreover, the number of connecting terminals, which may have open or defective connections caused by the ambient temperature or moisture, is also decreased so as to improve the reliability of the display panel. In addition, due to the cascade of the data driver chips, the printed circuit board and the flexible printed circuit board can achieve simple circuit designs, slim sizes and low cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device, comprising:
a printed circuit board;
a display panel, comprising:
a first substrate;
a plurality of scan lines disposed on the first substrate; and
a plurality of data lines substantially perpendicular to the scan lines and disposed on the first substrate;
a plurality of data driver chips cascaded to one another and mounted on the first substrate, wherein the cascaded data driver chips are electrically connected to the data lines and the printed circuit board; and
a scan driver circuit formed on the first substrate and electrically connected to the scan lines and the printed circuit board.

2. The display device as claimed in claim 1, wherein the scan driver circuit comprises at least one shift register electrically connected to the scan lines.

3. The display device as claimed in claim 2, wherein the shift register comprises a plurality of switching elements electrically connected to one another.

4. The display device as claimed in claim 3, wherein each of the switching elements comprises a top-gate thin-film transistor.

5. The display device as claimed in claim 3, wherein each of the switching elements comprises a bottom-gate thin-film transistor.

6. The display device module as claimed in claim 1, wherein the display panel further comprises:
an second substrate disposed parallel to the first substrate; and
a liquid crystal layer disposed between the first substrate and the second substrate.

7. The display device as claimed in claim 6, wherein the second substrate comprises at least a color filter layer.

8. The display device as claimed in claim 1, wherein the data driver chips and the scan driver circuit are disposed on two adjacent sides of the first substrate, respectively.

9. The display device as claimed in claim 1, further comprising:
a flexible printed circuit board disposed between the printed circuit board and the data driver chips.

10. The display device as claimed in claim 1, further comprising:
a flexible printed circuit board disposed between the printed circuit board and the scan driver circuit.

11. The display device as claimed in claim 1, wherein the scan lines and the data lines define a plurality of pixels, and the display panel further comprises a plurality of switching elements correspondingly configured within the pixels and electrically connected to the scan lines and the data lines.

12. The display device as claimed in claim 11, wherein each of the switching elements comprises a top-gate thin-film transistor.

13. The display device as claimed in claim 11, wherein each of the switching elements comprises a bottom-gate thin-film transistor.

14. The display device as claimed in claim 1, wherein the display panel is an organic light emitting diode display panel.
